(19) United States
(12) Patent Application Publication
(10) Pub. No.: US 2012/0123306 A1
(43) Pub. Date: May 17, 2012

(54) Apparatus and method for eye exercises

(76) Inventor: Raffaele Martini Pandozy, Dallas, TX (US)

(21) Appl. No.: 13/317,765

(22) Filed: Oct. 27, 2011

Related U.S. Application Data
(63) Continuation of application No. 11/897,130, filed on Aug. 28, 2007, now abandoned.
(60) Provisional application No. 60/900,525, filed on Feb. 9, 2007.

(51) Int. Cl. A61H 5/00

(52) U.S. Cl. 601/37

(57) ABSTRACT

Apparatus and method for eye-exercise utilizing a set of goggles, the set of goggles containing a display suitably positioned for a wearer to observe a set of LEDs, which when lit in a sequential manner cause the wearer to exercise the muscles of the eye. One set of LEDs is arranged in linear patterns along a horizontal line, a vertical line and two oblique lines at approximately 45 degrees to the horizontal. Another set of LEDs is arranged in a circular pattern around the periphery of the display. Alternate embodiments include the feature of illuminating cartoon characters or other interesting graphics so that the eye-exercise method may be effective for children.

### CROSS-REFERENCE TO RELATED APPLICATIONS

This application is a continuation of U.S. application Ser. No. 11/897,130 filed on Aug. 28, 2007, which claims priority to U.S. provisional patent application No. 60/900,525 filed Feb. 9, 2007.

### FIELD OF INVENTION

The present invention relates generally to human eye health. In particular, the invention teaches a method and apparatus for eye-exercising.

### BACKGROUND OF THE INVENTION

Studies have indicated that frequent users of computers, those that look at a computer screen for extended periods, can lose 1% to 2% of their eyesight per year. The minimal movement of the eyes causes the muscles of the eyes to atrophy resulting in diminishing eyesight. Children are especially susceptible and can lose their eyesight at a faster rate. With proper exercises, the eyesight lost due to weakened eye muscles about the eye can be regained. The regeneration rate in children is much greater than that of adults to the degree of 15% to 20%.

It is an object of the present invention to provide a simple to use and inexpensive means of eye exercise for the individual wishing to prevent premature eyesight loss due to atrophy of the eye muscles, especially the ciliary muscles.

According to ancient traditions in the Middle East and Asia, an effective eye exercise is to cause the eye to focus on an object (a pencil for example) while moving it in a variety of ways to bring the object to the edge of peripheral vision: up and down, side to side, diagonally up and down on both diagonals. The traditions include the technique of moving the object in a circle about the perimeter of peripheral vision in clockwise and counterclockwise directions. It is another object of the present invention to provide a programmed method for causing an individual to perform these same traditional eye movements.

The invention utilizes a set of goggles, the set of goggles containing a display suitably positioned for a wearer to observe a set of LEDs, which when lit in a sequential manner cause the wearer to exercise the muscles of the eye. One set of LEDs is arranged in linear patterns along a horizontal line, a vertical line and two oblique lines at approximately 45 degrees to the horizontal. Another set of LEDs is arranged in a circular pattern around the periphery of the display. The LEDs light up one at time through the various straight line patterns. The user follows the currently lit LED with their eyes through the full range of motion. One the straight line patterns have been completed, the LEDs light up around the circumference of each goggle in a circular pattern, first clockwise and then counterclockwise. A processor controls how fast the LEDs move through the pattern and how many repetitions of a given pattern are performed. An individual wishing to improve his or her vision is instructed to complete the exercises at least once a day and can do so in a variety of environments.

An alternate embodiment includes the feature of illuminating cartoon characters or other interesting graphics in the straight line and circular patterns so that the eye-exercise method may be useful and effective for children.

In the prior art there are a number of vision improvement systems. Zahn in U.S. Pat. No. 4,526,473 teaches the use of goggles for a sports display, but does not disclose any program for eye exercise.

Sadanage in U.S. Pat. No. 3,875,934 teaches a head-mounted eye exercise mechanism wherein the user views an image through a set of lenses and prisms that are rotating while varying the object position laterally and axially. The apparatus appears complex, utilizing optical components such as lenses and optical wedges which are not simple to manufacture and not inexpensive.

Blaine in U.S. Pat. No. 3,687,527 describes a handheld device and method for exercising the occulomotor accommodation system of the eyes by movement of distorted images. This system also has a relatively complex mechanical and optical system.

Mehr in U.S. Pat. No. 4,854,690 describes a goggle-like device worn on the head and having a single embedded light that flashes on and off at user settable frequencies. There is no peripheral exercise of the eye muscles in Mehr.

In Nimtsovitch, PCT W098/11819 an eye exercise apparatus is disclosed which is bench mounted or hand held, but not compatible with a device worn on the head.

Liberman in U.S. Patent Application 2004/0075811A1 describes several embodiments of an invention that includes the lighting of objects in vertical, horizontal and oblique lines using alternating wavelengths of light (colors of objects) to exercise the muscles of the eye. One embodiment of Liberman is a head set likened to a set of goggles used for virtual reality demonstrations or games. Liberman also teaches the technique for a table mounted device, a computer display and a large screen TV and in all cases teaches how to optimally arrange the sequence of colors which is the key inventive notion. A shortfall in Liberman is the lack of exercise for peripheral vision since Liberman does not describe an exercise of moving the eyes in a circular motion near the perimeter of peripheral vision.

### SUMMARY OF THE INVENTION

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

It is an object of the present invention to provide a set of eye-exercise goggles for exercising the muscles of the eye wherein the exercise consists of linear eye movement and circular eye movement, the set of eye-exercise goggles being attached to a wearer's head and positioned in front of the wearer's eyes.

The set of eye-exercise goggles comprises a left frame and a right frame to which a seal is attached for sealing light and to which a hinge is attached so that the frames may be folded together; a means for attaching the goggles to the head; a display assembly attached to each frame and set in front of the eyes. The display assembly is further comprised of a set of light emitting diodes (LEDs) arranged in a horizontal line, a set of LEDs arranged in a vertical line, a set of LEDs arranged in an oblique line, a set of LEDs arranged in a circle near the periphery of the display assembly, a control circuit electrically connected to the sets of LEDs and attached to display assembly containing electronic circuitry for automatically lighting LEDs in a sequential manner including lighting the LEDs in a circle around the periphery of the goggles. The display assembly also has at least one battery holder with battery and an on/off switch attached to battery and electrically connected to control circuit.

The eye-exercise goggles may have a repetition switch means for setting the number of repetitions of lighting the LEDs. The eye-exercise goggles may also have a timing switch means for setting the frequency at which the sequence of LEDs are lit.

The display assembly may include an inner cover between the LEDs and the wearer's eyes. Furthermore, in an alternate embodiment, said inner cover may have a set of objects imprinted on it that may include cartoon characters or other interesting characters, wherein the imprinted objects are arranged to display said characters to create an animation. It is a useful feature of the alternate embodiment of the present invention that the inner cover is constructed to snap into position on the frame and that the inner cover contains a means for being releasing from the snapped position.

The preferred embodiment of the present invention includes a method of eye-exercise using eye-exercise goggles to be worn on a wearer's head which contain a set of frames for holding a display assembly, the display assembly having a plurality of LEDs arranged in linear horizontal, linear vertical, linear oblique and circular patterns, the circular pattern being near the edge of peripheral vision and the linear patterns having both ends near the edge of peripheral vision; wherein the display assembly has a set of control electronics for controlling the lighting of LEDs, the method of eye-exercise comprising the steps of placing goggles on wearer's head, switching power on to the control electronics, lighting LEDs in the various linear patterns and lighting LEDs in clockwise and counterclockwise circular patterns.

The method of the preferred embodiment may include the step of setting a number of repetitions that the lighting of patterns may be repeated and furthermore execute the repetition of the lighting of each pattern by the number of repetitions. The frequency of LED lighting may also be adjusted.

In an alternate embodiment of the present invention, a method of eye-exercise uses eye-exercise goggles to be worn on a wearer's head which contain a set of frames for holding a display assembly, the display assembly having a plurality of objects capable of being illuminated, the objects being arranged in linear horizontal, linear vertical, linear oblique and circular patterns, the circular pattern being near the edge of peripheral vision and the linear patterns having both ends near the edge of peripheral vision; wherein the display assembly has a set of control electronics for controlling the illuminating of the set objects, the method of eye-exercise comprising the steps of placing goggles on wearer's head, switching power on to the control electronics, illuminating objects in various linear patterns and illuminating objects in clockwise and counterclockwise circular patterns.

The method of the alternate embodiment may include the step of setting a number of repetitions that the illumination of object patterns may be repeated and furthermore execute the repetition of the illumination of object patterns by the number of repetitions. The frequency of illumination may also be adjusted.

The alternate embodiment of the present invention includes a means for changing objects whereby the plurality of objects are imprinted on a removable inner cover which may be removed and replaced with a different set of objects.

### BRIEF DESCRIPTION OF THE DRAWINGS

FIG. 1 is a perspective drawing of the eye-exercise goggles of the preferred embodiment of the present invention.

FIG. 2A is a cross-sectional drawing of the left frame of the eye-exercise goggles of the preferred embodiment of the present invention.

FIG. 2B is a cross-sectional drawing of the right frame of the eye-exercise goggles of the preferred embodiment of the present invention.

FIG. 3A is a perspective drawing of the right display assembly of the preferred embodiment of the present invention.

FIG. 3B is a perspective drawing of the left display assembly of the preferred embodiment of the present invention.

FIG. 4 is a schematic drawing of the LED assembly of the preferred embodiment of the present invention.

FIG. 5 is an electrical schematic of a control circuit for the right frame within the preferred embodiment of the present invention.

FIG. 6 is an electrical schematic of a control circuit for the left frame within the preferred embodiment of the present invention.

FIG. 7 is a schematic drawing of the inner cover of a display assembly in alternate embodiment of the present invention wherein the inner cover has imprinted objects.

FIG. 8 is a circuit diagram of a modulation circuit that accomplishes a variation of LED intensity.

FIG. 9 is a drawing of a preferred embodiment of the invention.

FIG. 10 is a cross section view of the preferred embodiment of the frame of the invention.

FIGS. 11A and 11B show an alternate embodiment of the shape of the face shield for a preferred embodiment of the invention.

### DETAILED DESCRIPTION

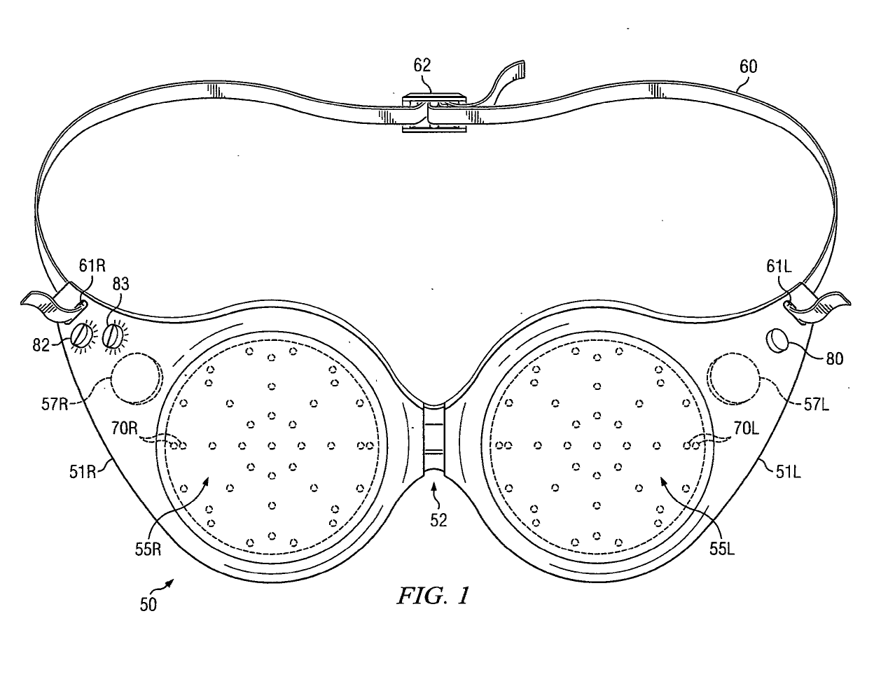

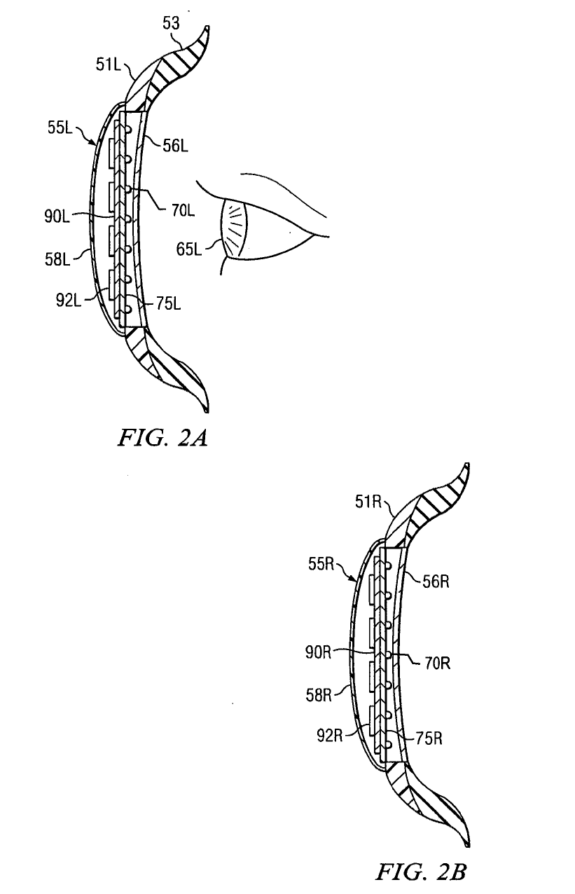

The present invention is explained herein according to a preferred embodiment which is shown in FIG. 1 as a perspective drawing of a pair of eye-exercise goggles 50 and in FIG. 2 as a cross-section of said goggles. Eye-exercise goggles 50 have a left frame 51L and a right frame 51R, the two frames being connected together with hinge 52, the left frame 51L having a left display assembly 55L and the right frame 51R having a right display assembly 55R. Left frame 51L has a first slot 61L and right frame 51R has a second slot 61R; a strap 60 is tied between first slot 61L and second slot 61R, strap 60 containing strap fastener 62 for adjusting strap 60 length. Surrounding left frame 51L and right frame 51R is a rubber seal 53 (FIG. 2) molded to fit typical human facial features. Eye-exercise goggles 50 are intended to be placed upon a users head with the two frames 51L and 51R covering the users eyes and strap 60 placed around the users head so as to hold the goggles comfortably and securely during movement of the head. Normal eyeglass type arms are also effective for securing the goggles to a users head. Rubber seal 53 together with left frame 51L and right frame 51R, left display assembly 55L and right display assembly 55R, block external light from entering the users eyes.

Eye-exercise goggles 50 serve as a means for exercising a user's eye muscles by lighting a number of LEDs built into the display assemblies and utilizing electronics contained therein. To the left display assembly 55L is attached a first set of LEDs 70L. Similarly, to the right display assembly 55R is attached a second set of LEDs 70R.

Referring to FIG. 2A, a cross-section of the left frame 51L shows that the first set of LEDs 70L in the left display assembly 55L are mounted on LED assembly 75L so that the LEDs illuminate the space toward eye 65L. A semi-transparent inner cover 56L is attached to the frame 51L to enclose the left display assembly 55L on the inside and an outer cover 58L is attached to the left frame 51L to enclose the left display assembly 55L on the outside. The LED assembly 75L is attached to a control circuit 90L. In the preferred embodiment the LED assembly 75L is made of a separate PCB and mechanically and electrically attached to control circuit 90L using board-to-board inline connectors. Control circuit 90L has attached to it a set of electronic IC components 92L that function together to control the LED assembly 75L so that LEDs in the first set of LEDs 70L illuminate in pre-defined sequences. The IC components 92L are typically low-power CMOS types.

Referring to FIG. 2B, right display assembly 55R and right frame 51R are built in a similar fashion to left display assembly 55L and left frame 51L, comprising LED assembly 75R housing the second set of LEDs 70R, inner cover 56R, outer cover 58R, control circuit 90R and a set of electronic components 92R are assembled in the same way as described for left display assembly 55L and left frame 51L.

Returning to FIG. 1, left frame 51L has a battery 57L stored in a battery compartment that is integrated into left frame 51L, battery 57L being electrically connected to control circuit 90L and providing power for it via an on/off button 80 which is integrated into the left frame 51L, on/off button 80 being connected to battery 57L and control circuit 90L. For the right eye, right frame 51R has a battery 57R stored in a battery compartment that is integrated into the frame, battery 57R being electrically connected to control circuit 90R and providing power for it via on/off button 80 also connected to battery 57R and control circuit 90R.

In the preferred embodiment of the present invention, other electronic controls are integrated into the goggle frames: a timing control button 82 which is electrically connected to control circuit 90L and is used for setting the rate at which the LEDs are illuminated in both frames; a repetitions control button 83, which is electrically connected to control circuit 90R and is used for setting a number of repeated illumination sequences.

The left frame 51L and right frame 51R are made of molded plastic as are inner covers 56L and 56R and as are outer covers 58L and 58R. LEDs are chosen to be green in the preferred embodiment. The inner covers are typically transparent to green light but may block other colors, the outer covers are typically opaque. The strap 60 is made of an elastic material such as rubber. The left frame 51L and right frame 51R, left display assembly 55L and right display assembly 55R are constructed so that the display assemblies 55L and 55R are held in place by snapping the inner covers and outer covers into place. Hinge 52 is made of a flexible material, preferably rubber and integrated with rubber seal 53 in the preferred embodiment of the present invention. With hinge 52 feature, eye-exercise goggles 50 may be folded compactly for convenience, for example, for use during an airline flight wherein eye-exercise goggles 50 may be used as either a stray light blocker for sleeping or as an eye-exerciser.

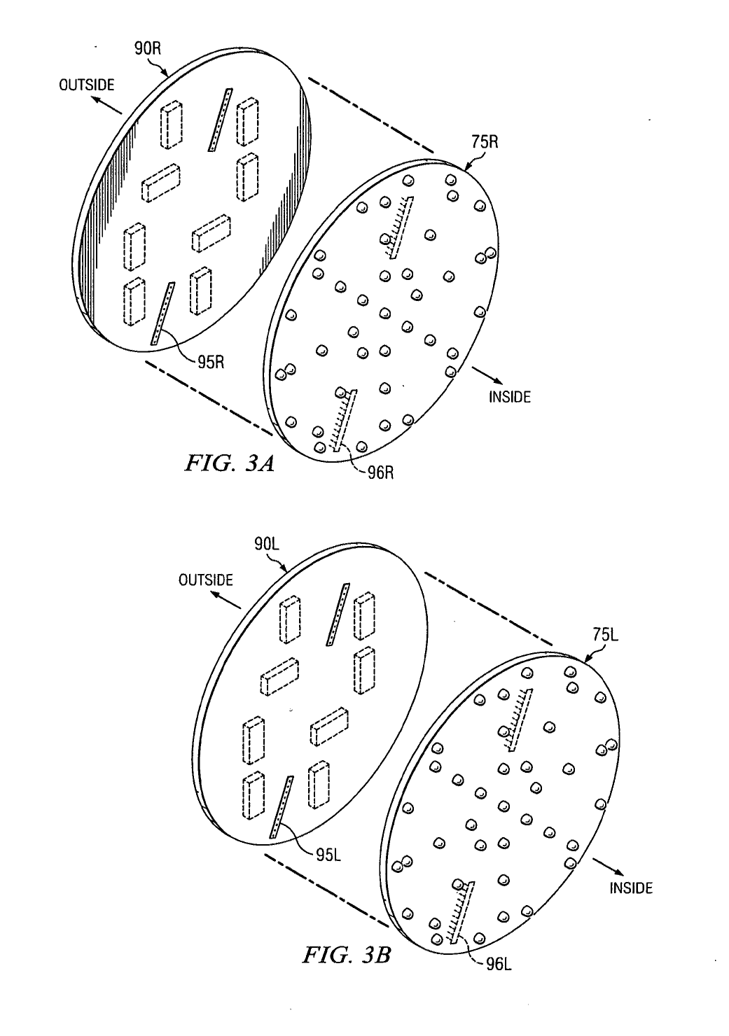

In the preferred embodiment of the present invention, control circuit 90R and LED assembly 75R in right display assembly 55R are constructed on two respective substrates. FIG. 3A is a perspective drawing of right display assembly 55R, wherein control circuit 90R has a first set of connectors 95R and LED assembly 75R has a second set of connectors 96R, the first set of connectors 95R mating with the second set of connectors 96R and thereby holding the respective substrates in electrical and mechanical contact with each other. The substrates are circular in shape with diameter of approximately 2 inches. The connectors within the sets of connectors 95R and 96R may be standard 0.100 inch spacing PCB headers and receptacles.

Referring to FIG. 3B, the left display assembly 55L also has two substrates, a control circuit 90L having a first set of connectors 95L and LED assembly 75L having a second set of connectors 96L, the first set of connectors 95L mating with the second set of connectors 96L and thereby holding the respective substrates in electrical and mechanical contact with each other. The substrates and contacts have essentially the same dimensions and mechanical specifications as the right display assembly 55R.

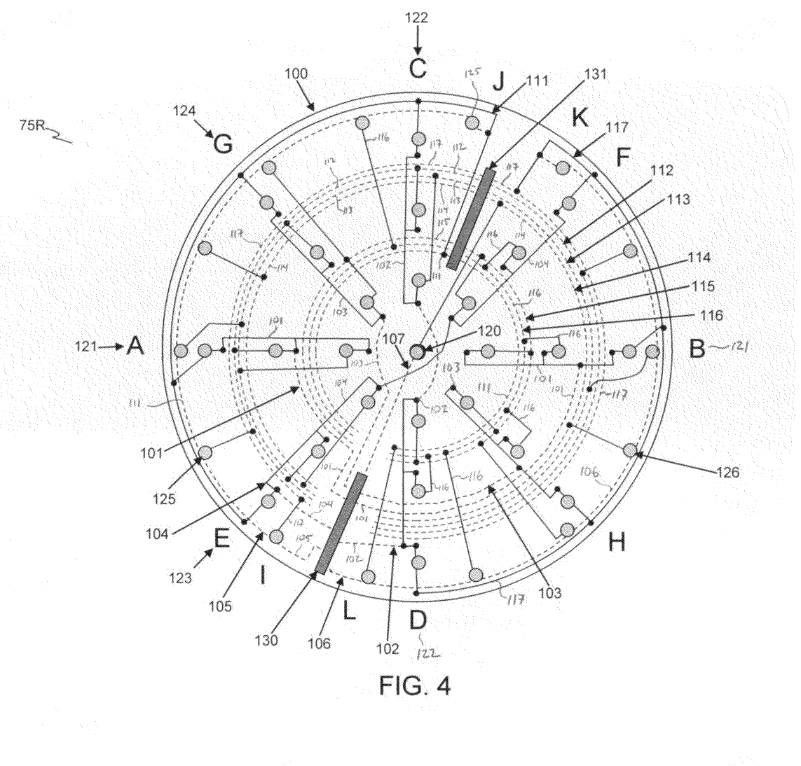

LED assembly 75L and LED assembly 75R are identical in the preferred embodiment of the present invention and described fully by LED assembly 75R of FIG. 4. LED assembly 75R has a substrate 100 upon which is mounted the second set of LEDs 70R comprising 39 LEDs organized into lines and a circle as follows: a center LED 120 placed in the center of the substrate, a first group of six LEDs 121 positioned along a horizontal line from A to B excluding the two outer LEDs, a second group of six LEDs 122 positioned along a vertical line from C to D, a third group of six LEDs 123 positioned along an oblique line from E to F, a fourth group of six LEDs 124 positioned along an oblique line from G to H, a fifth group of seven LEDs 125 positioned around the circumference of LED assembly 75R from Ito J, and a sixth group of seven LEDs 126 positioned around the circumference of LED assembly 75R from K to L.

Each group of LEDs achieves electrical connection to the control circuit 90R via the second set of connectors 96R which are further comprised of a cathode rail connector 130 and an anode rail connector 131. Cathode rail connector 130 is tied to a set of cathode electrical traces, the set of cathode electrical traces being comprised of trace 101, trace 102, trace 103, trace 104, trace 105, trace 106, and trace 107. Anode rail connector 131 is tied to a set of anode electrical traces, the set of anode electrical traces being comprised of trace 111, trace 112, trace 113, trace 114, trace 115, trace 116, and trace 117. The anodes of LEDs in the second set of LEDs 70R are connected to the anode electrical traces and the cathodes of LEDs in the second set of LEDs 70R are connected to the cathode electrical traces.

Groups of LEDs share the same cathode trace: the first group of LEDs 121 has all of their cathodes connected to trace 101, the second group of LEDs 122 has all of their cathodes connected to trace 102, the third group of LEDs 123 has all of their cathodes connected to trace 104, the fourth group of LEDs 124 has all of their cathodes connected to trace 103, the fifth group of LEDs 125 has all of their cathodes connected to trace 105, the sixth group of LEDs 126 has all of their cathodes connected to trace 106. The center LED has its cathode tied to trace 107.

The anode traces are connected such that trace 111 and trace 117 are always connected on the outside anodes of a group of LEDs, trace 111 being connected on the outermost LED in each group of LEDs near J, C, G, A, and E. Trace 117 is connected to the outermost LED in each group of LEDs near D, H, B, F, and K. The trace connections are laid in the order of: trace 112, trace 113, trace 114, trace 115, and trace 116, with trace 116 being closest to the center of the substrate. For example, in second group of LEDs 122, the outermost LED near C is tied to trace 111, the next LED below it is tied to trace 112, the third LED below that is tied to trace 113, the center LED is tied to trace 114, the fifth LED below that is tied to trace 115, the sixth LED below that is tied to trace 116 and the outer LED near D is tied to trace 117.

Control circuit 90R will drive the electrical voltages on the set of cathode electrical traces and the set of anode electrical traces of LED assembly 75R in such a way as to light the LEDs in a specific sequence by driving the cathode trace tied to a particular group of LEDs to ground potential, including the cathode trace 107 tied to the center LED, and then driving each anode trace sequentially to a positive potential. In the preferred embodiment of the present invention, the first group of LEDs 121 is lit first from A to B to A, then the second group of LEDs 122 is lit from C to D to C, then the third group of LEDs 123 is lit from E to F to E, then the fourth group of LEDs 124 is lit from G to H to G, then the fifth group of LEDs 125 is lit from I clockwise to J, then the sixth group of LEDs 126 is lit from K to L, then the sixth group of LEDs 126 is lit again from L to K, and finally the fifth group of LEDs 125 is lit from J to I.

Control circuit 90L for the left eye is synchronized with control circuit 90R for the right eye so that control circuit 90L will drive electrical voltages in synchronization with and in same specific sequence on LED assembly 75L as is done on LED assembly 75R.

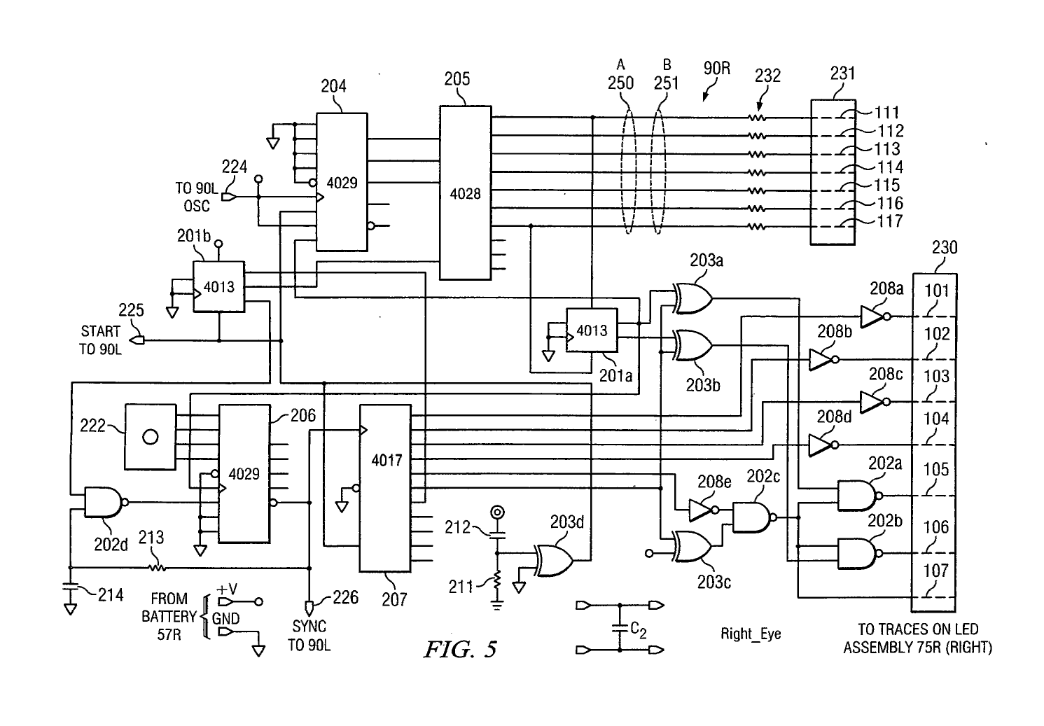

FIG. 5 is a drawing of the circuit schematic for control circuit 90R in the preferred embodiment of the present invention. Control circuit 90R has three main functional components that work together to drive LED assembly 75R: a cathode driver function for sequentially selecting and driving each group of LEDs starting with the first group of LEDs; and ending with the fifth and sixth groups of LEDs; an anode driver function for sequentially selecting and driving LED anodes of a selected group of LEDs; and a clear/stop function that resets control circuit 90R to a known starting state and leaves control circuit 90R in a known stopping state. The functions as described are taught by constructing a discrete component CMOS logic circuit. From this description, it will be apparent to those normally skilled in the art how to implement the logic in other embodiments using programmable logic devices, such as GALs or CPLDs, to replace all or some of the discrete logic components.

Control circuit 90R is connected to battery 57R, battery 57R supplying a +VCC rail from its positive terminal and a ground rail from its negative terminal.

Describing the anode driving function first, control circuit 90R has a first counter 204 which is a binary up/down counter of type 4029; a bcd decimal decoder 205 of type 4028; has a first D-type flip-flop 201a of type 4013 (one of two flip-flops on a 4013 IC); a second D-type flip-flop 201b (two of two flip-flops on the 4013 IC); and has access to an oscillator signal from OSC signal 224, operating at a frequency of about 1 Hz and varied by adjusting the timing control button 82.

In the following description, the logic function of each IC associated with the given pin is shown in parenthesis. Logic “high” is by definition in a state near +VCC potential and logic “low” is in a state at ground potential.

First counter 204 pins 4, 3, 13 and 12 (preset inputs PA, PB, PC and PD) and pin 5 (EN) are tied to ground, pin 15 (CLOCK) is tied to OSC signal 224, pin 9 (BIN/BCD) is tied “high” placing the device in binary mode, pin 1 (LOAD) is tied to START signal 225 (described below), pin 10 (UP/DN) is connected to first flip-flop 201a pin 1 (Q), and pins 6, 11, and 14 (bcd outputs A, B and C) are tied to pins 10, 13, and 12 (bcd inputs A, B, and C) respectively, of decoder 205.

Decoder 205 pin 11 (bcd input D) is tied to pin 13 (Q) of flip-flop 201b. Decoder 205 pins 3, 14, 2, 15, 1, 6, 7 (outputs 0, 1, . . . 6) are tied to anode traces 111, 112, . . . , 117 of LED assembly 75R, respectively, through a set of current limiting resistors 232 to anode connector 231 also contained on control circuit 90R. Anode connector 231 mates with anode rail connector 131 of LED assembly 75R to complete the connection to traces 111, 112, . . . 117 of LED assembly 75R. Decoder 205 pin 3 (output 0) is also tied to pin 6 (SET) of first flip-flop 201a; pin 7 (output 6) is also tied to pin 4 (RST) of first flip-flop 201a.

First flip-flop 201a pins 3 and 5 (inputs CL and D) are tied to ground, pin 1 (Q) is also tied to pin 5 (in) of an XOR gate 203a (described further below), pin 2 (not Q) is tied to pin 1 (in) of an XOR gate 203b, pin 1 (Q) is also tied to pin 15 (CLOCK) of a second binary up/down counter 206 (described further below). XOR gate 203a and second binary up/down counter 206 are parts within control circuit 90R.

The anode driving function is as follows: On a positive pulse on START signal 225, first counter 204 loads a zero into its counter and decoder 205 sets output 0 (zero) to logic “high,” all other outputs to logic “low.” In turn, first flip-flop 201a sets its Q output to logic “high” forcing first counter 204 to count forward. After START 225 pulse returns to logic “low,” first counter 204 begins to count forward, clocked by OSC signal 224. When a count of 6 (six) is obtained, decoder 205 sets output 6 (six) to “high” and all other outputs “low,” causing first flip-flop 201a to reset its Q output to logic “low.” This action then forces first counter 204 to count backward until decoder 205 sets output 0 (zero) to logic “high” again. First counter 204 continues to count forward to 6 (six) and backward to 0 (zero) repeatedly.

As decoder 205 outputs are made “high,” so are their associated traces 111,112, . . . 117 of LED assembly 75R, thereby causing a corresponding LED on LED assembly 75R to be lit in a selected group of LEDs, the groups of LEDs having their cathodes tied together so that a group so selected will have its cathode traces driven to ground. The cathode driving function of control circuit 90R selects and drives the groups of LEDs.

Describing the cathode driving function of control circuit 90R in detail, control circuit 90R has a second binary up/down counter 206 of type 4029 operated in a decrementing mode; a decade counter 207 of type 4017; a selector switch 222 which stores a number of repetitions; and a set of XOR gates XOR 203a, XOR 203b, XOR 203c and XOR 203d each of which is one quadrant of IC type 4070. Control circuit 90R also has a set of NAND gates, NAND 202a, NAND 202b, NAND 202c and NAND 202d each of which is one quadrant of IC type 4011. Control circuit 90R also has a set of inverting buffers, INV 208a, INV 208b, . . . INV 208e all of which are contained on an inverter IC of type 4069. Control circuit 90R also has a reload circuit associated with second binary up/down counter 206 consisting of resistor 213, capacitor 214 and NAND gate 202d. Selection switch 222 is connected to repetitions control button 83 contained on right frame 51R.

Second binary up/down counter 206 pins 5, 9, and 10 (EN, BIN/BCD, and UP/DN) are tied “low” so that second binary up/down counter 206 is enabled and operating in bcd mode with decremental counting; pin 1 (LOAD) is tied to the output of NAND 202d. Second binary up/down counter 206 pins 6, 11, 14, and 2 (A, B, C and D inputs) are connected to selector switch 222 which outputs its number of repetitions, selected from 1 to 9, on these same pins. Second binary up/down counter 206 pin 7 (OUT) is tied to decade counter 207 pin 14 (CLOCK) and further tied to SYNC signal 226.

Decade counter 207 pin 13 (EN) is tied to ground, pin 15 (RST) is tied to START signal 225. Decade counter 207 pins 3, 2, 4, 7 and 10 (outputs 0 . . . 4) are tied to respectively to the first inverter IC input pins 5, 9, 1, 13 and 3 associated with INV 208a, INV 208b, INV 208c, INV 208d and INV 208e. Outputs of first inverter IC on pins 4, 10, 3 and 11 are tied to trace 101, trace 102, trace 103 and trace 104 of LED assembly 75R, respectively so that decade counter 207 outputs (0-3) drive the first group of LEDs 121, second group of LEDs 122, third group of LEDs 123 and fourth group of LEDs 124 on LED assembly 75R.

Decade counter 207 pin 1 (output 5) is tied to pin 12 (in) of XOR 203c. Pin 13 (in) of XOR 203c is tied to +VCC so that XOR 203c acts as a non-inverting buffer. Decade counter 207 pin 1 (output 5) is also tied to pin 6 (in) of XOR 203a and to pin 2 (in) of XOR 203b. Pin 5 (output 6) of decade counter 207 is tied to pin 8 (SET) second flip-flop 201b.

Pin 6 (out) of INV 208a, pin 8 (out) of INV 208b, pin 10 (out) of INV 208c, pin 12 (out) of INV 208d, pin 10 (out) of NAND gate 202a, pin 11 (out) of NAND gate 202b and pin 3 (out) of NAND gate 202c are tied to, respectively, to trace 101, trace 102, . . . trace 107 of LED assembly 75R through cathode connector 230 being mated to cathode rail connector 130 of LED assembly 75R.

NAND gate 202a pin 8 (in) is tied to XOR gate 203a pin 4 (out). NAND gate 202a pin 9 (in) is tied to NAND gate 202c pin 3 (out).

NAND gate 202b pin 12 (in) is tied to XOR gate 203b pin 3 (out). NAND gate 202b pin 13 (in) is tied to NAND gate 202c pin 3 (out).

NAND gate 202c pin 2 (in) is tied to XOR gate 203c pin 11 (out). NAND gate 202c pin 1 (in) is tied to INV 208e pin 4 (out).

The reload circuit associated with second binary up/down counter 206 is connected as follows: pin 7 (OUT) of second binary up/down counter 206 is connected to pin 5 (in) of NAND 202d through resistor 213; pin 5 (in) of NAND 202d is also connected to capacitor 214, the other terminal of capacitor 214 being connected to ground. Pin 6 of NAND 202d is connected to the second flip-flop 201b pin 12 (not Q).

The cathode driving function is as follows: On a positive pulse on START signal 225, decade counter 207 loads a zero and sets its output 0 to logic “high,” all other outputs to logic “low.” This action enables the first group of LEDs 121 on LED assembly 75R. A logic “high” appears on pin 5 of NAND 202d due to the action of the clear/stop function (described below) resulting from the positive pulse on START signal 225. A logic “low” initially appears on pin 6 of NAND 202d and then, after a delay determined by the RC time constant of resistor 213 and capacitor 214, pin 6 goes “high.” This causes a brief logic “high” to occur at pin 1 of second binary up/down counter 206, thereby loading the counter with the preset number of repetitions and then enabling the second binary up/down counter 206 to count clock signals.

Second binary up/down counter 206 is clocked every time the first flip-flop 201a is set, that being when the first counter 204 has reached a count of zero after cycling forward and backward through all the LEDs in the enabled group of LEDs. Second binary up/down counter 206 decrements by the number of repetitions, down to zero allowing first counter 204 to cycle the number of repetitions through all the LEDs in the enabled group of LEDs. Upon reaching a count of zero, pin 7 (OUT) of second binary up/down counter 206 goes to ground which causes reload circuit to reload second binary up/down counter 206 with the number of repetitions, and then clocks decade counter 207 causing it to increment its count by one. When decade counter increments its count by one, the next group of LEDs are enabled driving their cathodes to ground. During the immediate oscillator cycles after a positive pulse on START signal 225, the enabled group is the first group of LEDs 121 on LED assembly 75R. After decade counter 207 is incremented the second group of LEDs 122 is enabled and so on until output 6 of decade counter 207 goes “high” at which time the control circuit 90R will stop.

The logic to set the voltage on traces 101, 102, . . . 104 of LED assembly 75R to ground and thereby enable their corresponding groups of LEDs is straightforward: when an output pin of decade counter 207 is driven “high” its corresponding trace is driven “low.”

The remaining logic of the cathode driving function of control circuit 90R uses the XOR gates 203a-203c, NAND gates 202a-202c, and inverter INV 208e to drive the voltage on trace 105, trace 106 and trace 107 of LED assembly 75R. A straightforward way to describe the remaining logic of the cathode driving function is by a truth table. The truth table of Table 1 has two input columns: counter value, meaning the value contained within decade counter 207 and on its output pins; Q, meaning that a one (1) is entered if pin 1 of first flip-flop 201a is “high,” zero (0) if the same pin 1 is logic “low,” X is entered if it doesn't matter. Note that Q=1 implies that the LEDs are being lit from trace 111 to trace 117 and that Q=0 implies that the LEDs are being lit backwards from trace 117 down to trace 111.

The truth table of table 1 has three output columns: trace 105 is a zero (0) if logic “low” and the fifth group of LEDs is enabled, trace 105 is a one (1) if logic “high” and the fifth group of LEDs is not enabled; trace 106 is a zero (0) if logic “low” and the sixth group of LEDs is enabled, trace 105 is a one (1) if logic “high” and the sixth group of LEDs is not enabled; trace 107 is a zero (0) if logic “low” and the center LED is enabled, trace 107 is a one (1) if logic “high” and the center LED is not enabled.

TABLE 1
Truth table for LED group selection logic.

| | |
|---|---|
| Inputs | Outputs |

| Decade counter 207 | | Trace | Trace | Trace |
|---|---|---|---|---|
| Counter value | Q | 105 | 106 | 107 |
| 0, 1 . . . 3 | X | 1 | 1 | 0 |
| | 1 | 0 | 1 | 1 |
| 4 | 0 | 1 | 0 | 1 |
| 5 | 1 | 0 | 1 | 1 |
| 5 | 0 | 1 | 0 | 1 |
| | X | 1 | 1 | 1 |

The clear/stop function is now described. XOR gate 203d pin 9 (in) is connected to resistor 211 and capacitor 212, the other side of capacitor 212 being connected to +VCC, the other side of resistor 211 being connected to ground. XOR gate 203d pin 8 (in) is connected to ground. When control circuit 90R is first connected to +VCC, meaning that on/off switch 80 is in the on position, the combination of XOR gate 203d, capacitor 212 and resistor 211 creates a brief positive pulse on pin 10 (output) of XOR gate 203d. Pin 10 of XOR gate 203d is tied to START signal 225 and besides the connections already explained, is tied to pin 10 (RST) of second flip-flop 201b. Other clearing actions have already been explained in the context of the anode and cathode driving functions.

Second flip-flop 201b has pin 11 (CL) and pin 9 (D) tied to ground. Upon receiving a positive pulse on START signal 225, second flip-flop 201b resets pin 13 (Q) “low” and sets pin 12 (not Q) “high.” Second flip-flop 201b remains in this state until decade counter 207 counts up to a value of six (6). Then pin 8 (SET) of second flip-flop 201b is driven “high” which sets pin 13 (Q) “high” and resets pin 12 (not Q) “low,” thereby turning off all LEDs and disabling the cathode driving function from further operation since the states of second binary up/down counter 206 and decade counter 207 will remain fixed.

In the preferred embodiment of the present invention, the left frame 51L contains a left display assembly 55L in which its LED assembly 75L and control circuit 90L operate together and in synchronization with control circuit 90R to produce the same LED lighting patterns as those produced by control circuit 90R. In particular, the OSC signal 224, START signal 225, SYNC signal 226 and ground are connected via ribbon cable to the left control circuit 90L.

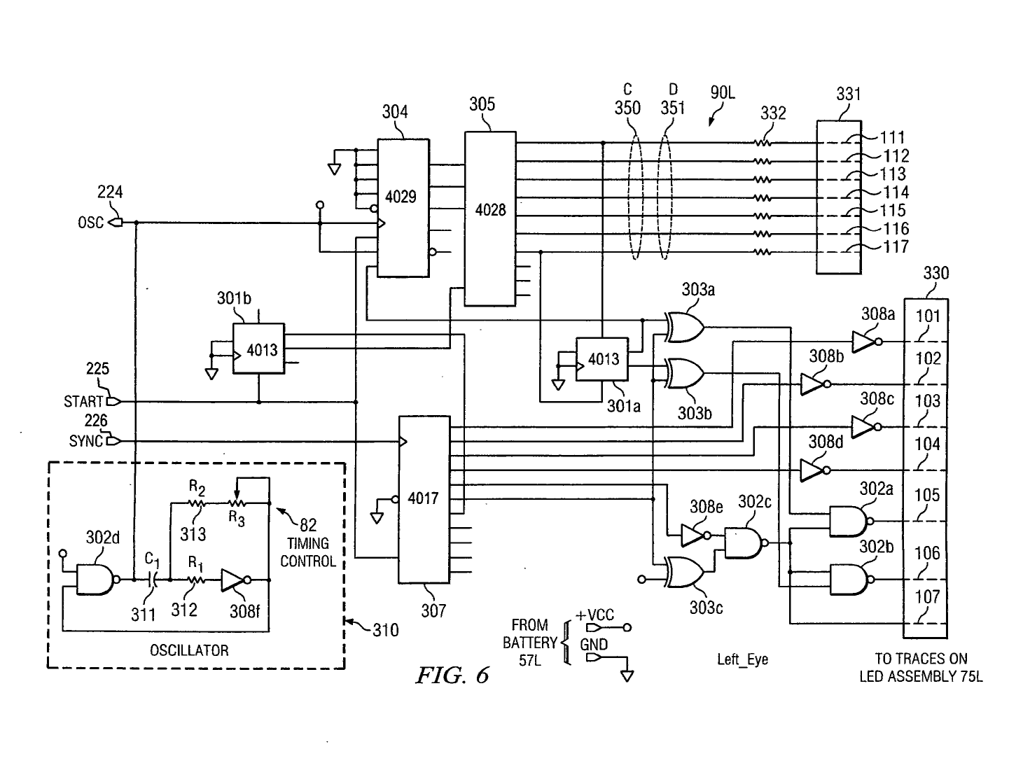

FIG. 6 is a drawing of the circuit schematic for control circuit 90L in the preferred embodiment of the present invention. Control circuit 90L has three main functional components that work together to drive LED assembly 75L: a cathode driver function for sequentially selecting and driving each group of LEDs starting with the first group of LEDs and ending with the fifth and sixth groups of LEDs; an anode driver function for sequentially selecting and driving LED anodes of a selected group of LEDs; and an oscillator function 310 that produces OSC signal 224. The functions as described are taught by constructing a discrete component CMOS logic circuit. From this description, it will be apparent to those normally skilled in the art how to implement the logic in other embodiments using programmable logic devices, such as GALs or CPLDs, to replace all or some of the discrete logic components.

Control circuit 90L is connected to battery 57L, battery 57L supplying a +VCC potential from its positive terminal and a ground potential from its negative terminal.

Describing the anode driving function first, control circuit 90L has a first counter 304 which is a binary up/down counter of type 4029; a bcd decimal decoder 305 of type 4028; a first D-type flip-flop 301a of type 4013 (one of two flip-flops on a 4013 IC); a second D-type flip-flop 301b (two of two flip-flops on the 4013 IC); and is connected to oscillator signal OSC signal 224.

First counter 304 pins 4, 3, 13 and 12 (preset inputs PA, PB, PC and PD) and pin 5 (EN) are tied to ground, pin 15 (CLOCK) is tied to OSC signal 224, pin 9 (BIN/BCD) is tied “high” placing the device in binary mode, pin 1 (LOAD) is tied to START signal 225, pin 10 (UP/DN) is connected to first flip-flop 301a pin 1 (Q), and pins 6, 11, and 14 (bcd outputs A, B and C) are tied to pins 10, 13, and 12 (bcd inputs A, B, and C) respectively, of decoder 305.

Decoder 305 pin 11 (bcd input D) is tied to pin 13 (Q) of second flip-flop 301b. Decoder 305 pins 3, 14, 2, 15, 1, 6, 7 (outputs 0, 1, . . . 6) are tied to anode traces 111, 112, . . . , 117 of LED assembly 75L, respectively, through a set of current limiting resistors 332 to anode connector 331 also contained on control circuit 90L. Anode connector 331 mates with anode rail connector 131 of LED assembly 75L to complete the connection to traces 111, 112, . . . 117 of LED assembly 75L. Decoder 305 pin 3 (output 0) is also tied to pin 6 (SET) of first flip-flop 301a; pin 7 (output 6) is also tied to pin 4 (RST) of first flip-flop 301a.

First flip-flop 301a pins 3 and 5 (inputs CL and D) are tied to ground, pin 1 (Q) is also tied to pin 5 (in) of an XOR gate 303a (described further below), pin 2 (not Q) is tied to pin 1 (in) of an XOR gate 303b. XOR gate 303a is a part included on control circuit 90L.

The anode driving function is as follows: On a positive pulse on START signal 225, first counter 304 loads a zero into its counter and decoder 305 sets output 0 (zero) to logic “high,” all other outputs to logic “low.” In turn, first flip-flop 301a sets its Q output to logic “high” forcing first counter 304 to count forward. After START signal 225 pulse returns to logic “low,” first counter 304 begins to count forward, clocked by OSC signal 224, in synchronization with first counter 204 of control circuit 90R. When a count of 6 (six) is obtained, decoder 305 sets output 6 (six) to “high” and all other outputs “low,” causing first flip-flop 301a to reset its Q output to logic “low.” This action then forces first counter 304 to count backward until decoder 305 sets output 0 (zero) to logic “high” again. First counter 304 continues to count forward to 6 (six) and backward to 0 (zero) repeatedly.

As decoder 305 outputs are made “high,” so are their associated traces 111, 112, . . . 117 of LED assembly 75L, thereby causing the corresponding LED on LED assembly 75L to be lit within a selected group of LEDs, the groups of LEDs having their cathodes tied together so that a group so selected will have its cathode traces driven to ground. The cathode driving function of control circuit 90L selects and drives the groups of LEDs on LED assembly 75L.

Describing the cathode driving function of control circuit 90L now, has a decade counter 307 of type 4017, has a set of XOR gates XOR 303a, XOR 303b and XOR 303c each of which is one quadrant of IC type 4070. Control circuit 90L also has a set of NAND gates, NAND 302a, NAND 302b, NAND 302c and NAND 302d each of which is one quadrant of IC type 4011. Control circuit 90L also has a set of inverting buffers, INV 308a, INV 308b, . . . INV 308e all of which are contained on an inverter IC of type 4069.

Decade counter 307 pin 13 (EN) is tied to ground, pin 15 (RST) is tied to START signal 225 and pin 14 is tied to SYNC signal 226. Decade counter 307 pins 3,2,4, 7 and 10 (outputs 0 . . . 4) are tied to respectively to the first inverter IC input pins 5, 9, 1, 13 and 3 associated with INV 308a, INV 308b, INV 308c, INV 308d and INV 308e. Outputs of first inverter IC on pins 4, 10, 3 and 11 are tied to trace 101, trace 102, trace 103 and trace 104 of LED assembly 75L respectively so that decade counter 307 outputs (0-3) drive the first group of LEDs 121, the second group of LEDs 122, the third group of LEDs 123 and the fourth group of LEDs 124 of LED assembly 75L.

Decade counter 307 pin 1 (output 5) is tied to pin 12 (in) of XOR 303c. Pin 13 (in) of XOR 303c is tied to +VCC so that XOR 303c acts as a non-inverting buffer. Decade counter 307 pin 1 (output 5) is also tied to pin 6 (in) of XOR 303a and to pin 2 (in) of XOR 303b. Pin 5 (output 6) of decade counter 307 is tied to pin 8 (SET) second flip-flop 301b.

Pin 6 (out) of INV 308a, pin 8 (out) of INV 308b, pin 10 (out) of INV 308c, pin 12 (out) of INV 308d, pin 10 (out) of NAND gate 302a, pin 11 (out) of NAND gate 302b and pin 3 (out) of NAND gate 302c are tied to, respectively, to trace 101, trace 102, . . . trace 107 of LED assembly 75L through cathode connector 330 being mated to cathode rail connector 130 on LED assembly 75L.

NAND gate 302a pin 8 (in) is tied to XOR gate 303a pin 4 (out). NAND gate 302a pin 9 (in) is tied to NAND gate 302c pin 3 (out).

NAND gate 302b pin 12 (in) is tied to XOR gate 303b pin 3 (out). NAND gate 302b pin 13 (in) is tied to NAND gate 302c pin 3 (out).

NAND gate 302c pin 2 (in) is tied to XOR gate 303c pin 11 (out). NAND gate 302c pin 1 (in) is tied to INV 308e pin 4 (out).

The cathode driving function is as follows: On a positive pulse on START signal 225, decade counter 307 loads a zero and sets its output 0 to logic “high,” all other outputs to logic “low.” This action enables the first group of LEDs 121 through trace 101 on LED assembly 75L.

SYNC signal 226 clocks decade counter 307 causing it to increment its count by one. When decade counter increments its count by one, the next group of LEDs are enabled driving their cathodes to ground. During the immediate oscillator cycles after a positive pulse on START signal 225, the enabled group is the first group of LEDs 121 on LED assembly 75L. After decade counter 307 is incremented the second group of LEDs 122 is enabled and so on until output 6 of decade counter 307 goes “high” at which time the control circuit 90L will stop.

The logic to set the voltage on traces 101, 102, . . . 104 of LED assembly 75L to ground and thereby enable their corresponding groups of LEDs is straightforward: when an output pin of decade counter 307 is driven “high” its corresponding trace is driven “low.”

The remaining logic of the cathode driving function of control circuit 90L uses the XOR gates 303a-303c, NAND gates 302a-302c, and inverter INV 308e to drive the voltages on trace 105, trace 106 and trace 107 of LED assembly 75L, the remaining logic being described by the truth table of Table 1 with decade counter 307 substituted for decade counter 207 in column 1.

Second flip-flop 301b has pin 11 (CL) and pin 9 (D) tied to ground. Upon receiving a positive pulse on START signal 225, second flip-flop 301b resets pin 13 (Q) “low” and sets pin 12 (not Q) “high.” Second flip-flop 301b remains in this state until decade counter 307 counts up to a value of six (6). Then pin 8 (SET) of second flip-flop 301b is driven “high” which sets pin 13 (Q) “high” and resets pin 12 (not Q) “low,” thereby turning off all LEDs and disabling the cathode driving function on control circuit 90L from further operation since the states of second binary up/down counter 206 and decade counter 307 will remain fixed.

Oscillator function 310 of control circuit 90L is accomplished using an astable multivibrator comprised of NAND 302d functioning as an inverter with one input tied to +VCC . The other input, pin 6, is tied to the output of an inverter INV 308f, pin 2, which is part of the inverter IC 4069. The output of NAND 302d, pin 4, is connected to capacitor 311; resistor 312 and resistor 313 are connected to capacitor 311; resistor 312 is connected to the input, pin 1, of INV 308f. Timing control 82 potentiometer is connected to resistor 313 and the output of INV 308f, pin 2. The values of capacitor 311, resistor 312 and resistor 313, and timing control 82 potentiometer are chosen to put the frequency of OSC signal 224 in the range of 0.3 Hz to 3 Hz, the nominal values of the components being: capacitor 311, 10 uf; resistor 312 470 k-ohm; resistor 313, 10 k-ohm; timing control 82 potentiometer, zero to 100 k-ohm.

In another aspect of the present invention inner cover 56L and inner cover 56R may be attached to frame 51L and frame 51R in such a way that they are easily removed and replaced by different inner covers with different sets of objects imprinted on them. A set of such removable inner covers may accompany the eye-exercise glasses so that a child may choose between them, increasing the probability that the child will successfully complete the exercises. One mechanism for attaching inner covers 56L and 56R to the frames 51L and 51R, respectively, includes a snap fit with a release tab on the inner cover to pull for removal. Inner cover 56L has a release tab 410 which may also serve to locate the position of the objects in alignment with the LEDs.

In a second embodiment of the present invention, LED light intensity is modified during the eye exercise and in the preferred embodiment the light intensity modification is asynchronous with OSC signal 224. The “rate” of advancement of the pattern is referred to as the “rate vector.” The variation of LED intensity is referred to as the intensity vector. The rate vector and the “intensity vector” can be in phase or out of phase and can be synchronous, asynchronous or position related. Those skilled in the art will also recognize that a function can be impressed on the difference between the rate vector and the intensity vector. Variation of LED intensity has two primary beneficial effects on the wearer: first, LED intensity variation causes the wearer to concentrate more acutely on the position of the LEDs so that the exercise more efficiently stimulates the brain to eye coordination; second, LED intensity variation causes stimulation of the pupil function. The intensity vector can capitalizes on the natural affinity of human eye physiology for tracking a lighted object.

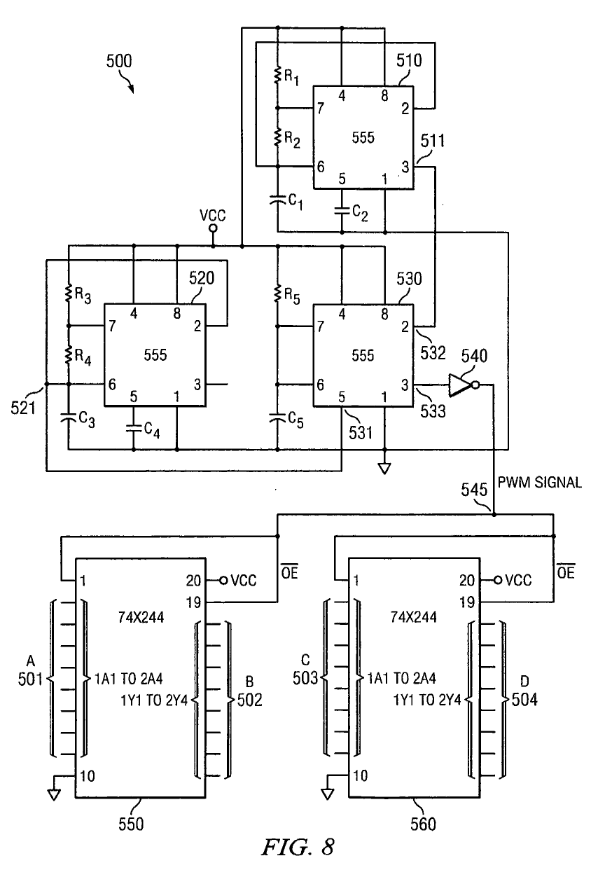

FIG. 8 shows a circuit diagram of a modulation circuit that accomplishes a variation of LED intensity. The modulation circuit 500 has inputs 501 and outputs 502 which are comprised of eight input lines and eight output lines that are inserted between points A and B in control circuit 90R, labeled point 250 and point 251, respectively in FIG. 5; and inserted between points C and D in control circuit 90L labeled point 350 and point 351, respectively in FIG. 6. Points A and B represent a position in control circuit of 90R between decoder 205 and LED current limiting resistors 232. Points C and D represent a position in control circuit of 90L between the decoder 305 and LED current limiting resistors 332.

Modulation circuit 500 is comprised of a set of three 555 type timer integrated circuits: astable oscillator 510, astable modulator 520 and pulse width modulator (PWM) 530, wherein PWM 530 is connected by inverter 540 to the output enable pins of two eight-line tri-state buffers of the 74×244 type. The 555 ICs and the 74×244 are CMOS types for low power: for example one-half of a TLC556 dual timer from Texas Instruments and a 74HC244 from Philips Semiconductors. Astable oscillator 510 is a 555 timer connected in an astable mode of oscillation wherein the frequency of oscillation is given by fo=1.44/(R1+R2)C1. Output of astable oscillator 510 on output pin 511 is the trigger input of PWM 530 on pin 532 and sets the frequency of the PWM signal 545 generated on the output of inverter 540, inverter 540 being connected to pin 533 of PWM 530. Astable modulator 520 is a 555 timer connected in an astable mode of operation wherein the frequency of oscillation is given by fm=1.44/(R3+R4)C3. fm is typically between 0.2 and 0.4 Hz while f0 is on the order of 60 to 100 Hz, f0 being large enough to avoid not to cause observable flicker. The output of astable modulator 520 is taken from connection 521 wherein a sawtooth like waveform is generated; connection 521 being connected to the modulation input pin 531 of PWM 530. PWM 530 is a 555 timer connected in a pulse width modulation mode wherein the time constant R5*C5 is typically about one-half of (R1+R2)C1. As the amplitude of the sawtooth like waveform increases and decreases, the duty cycle of pulses in PWM signal 545 increases and decreases. The astable oscillator and pulse width modulation modes of 555 timer ICs are well-known in the art and described in detail in a number of publications, one such publication being the datasheets for the TLC555 and TLC556 from Texas Instruments Corporation.

PWM signal 545 drives the output enable pins of two tri-state buffers, buffer 550 and buffer 560; the buffer 550 having inputs 501 and outputs 502 and the buffer 560 having inputs 503 and outputs 504. When PWM signal 545 is logic high the outputs 502 and 504 are driven to a high impedance state so that the inputs signals 501 and 503 do not pass through to the LEDs: the LEDs are turned off. When PWM signal 545 is logic low, the inputs 501 and 503 appear at the outputs 502 and 504, respectively, and the LEDs are driven according to the decoder 205 and decoder 305 outputs, respectively. The LEDs being driven according to PWM signal 545 have a power variations applied to them according to the duty cycle variations in PWM signal 545, the power variation being at the frequency of the sawtooth modulation which is fm.

Typical values for components of FIG. 8 are for resistors: R1=5 k-ohm, R2=75 k-ohm, R3=400 k-ohm, R4=1.2 M-ohm, R5=100 k-ohm; for capacitors C1=0.1 uF, C3=2 uF and C5=0.1 uF; C2 and C3 are bypass capacitors nominally 0.01 uF.

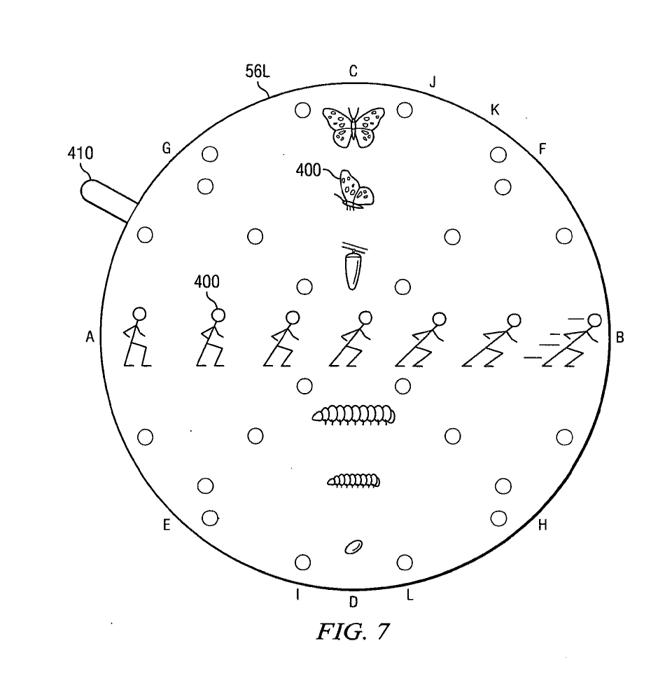

A feature of the present invention is the modification of inner cover 56L and inner cover 56R by imprinting objects on them as shown in FIG. 7. Inner cover 56L has a set of objects 400 imprinted thereon. Imprinted objects 400 are illuminated as the LEDs are lit in sequence according to A to B to A, C to D to C, E to F to E, G to H to G, I to J, K to L, L to K, J to I patterns. Set of objects 400 may be chosen to have a wide appeal to children, utilizing popular cartoon characters or other figures that serve to hold the attention of a child's eye. Animation may be accomplished by having ‘frames’ of objects become illuminated while the LEDs are lit in sequence, for example the life cycle of a butterfly could be shown around the circular set of LEDs from I to J to K to L. The number of objects is generally not limited to the number of LEDs. Objects on inner cover 56R are made to match the objects on inner cover 56L.

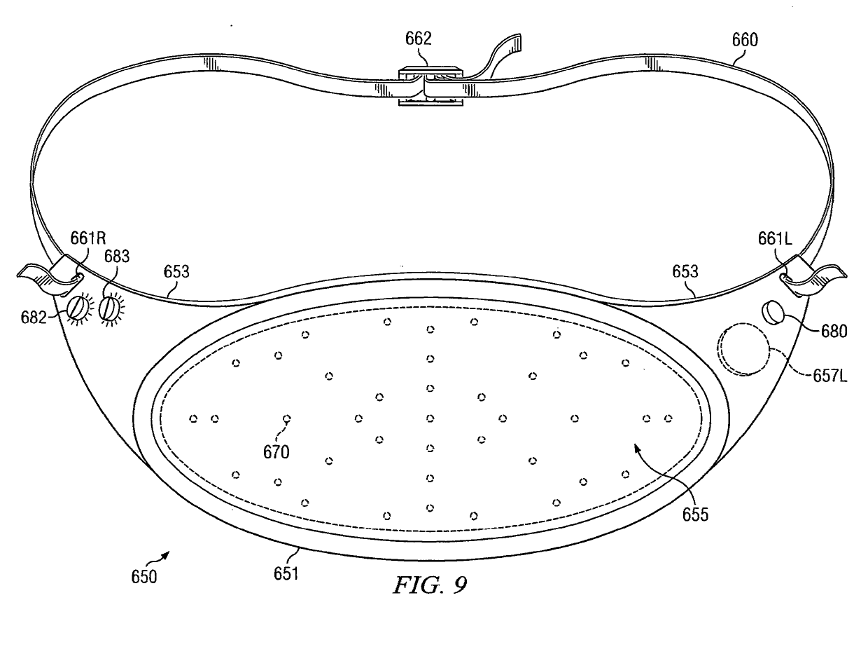

In another embodiment of the present invention the eye exercise goggles take the form of scuba diving goggles wherein a single display is viewed by both eyes. Such a set of goggles is shown in FIG. 9. Eye-exercise goggles 650 have a single frame 651 with a single display assembly 655. Left side of frame 651 has a first slot 661L and right side of frame 651 has a second slot 661R; a strap 660 is tied between first slot 661L and second slot 661R, strap 660 containing strap fastener 662 for adjusting strap 660 length. Surrounding frame 651 is a rubber seal 653 molded to fit typical human facial features. Eye-exercise goggles 650 are intended to be placed upon a user's head with the frame 651 covering the user's eyes and strap 660 placed around the user's head so as to hold the goggles comfortably and securely during movement of the head. Rubber seal 653 together with frame 651 and display assembly 655 block external light from entering the user's eyes.

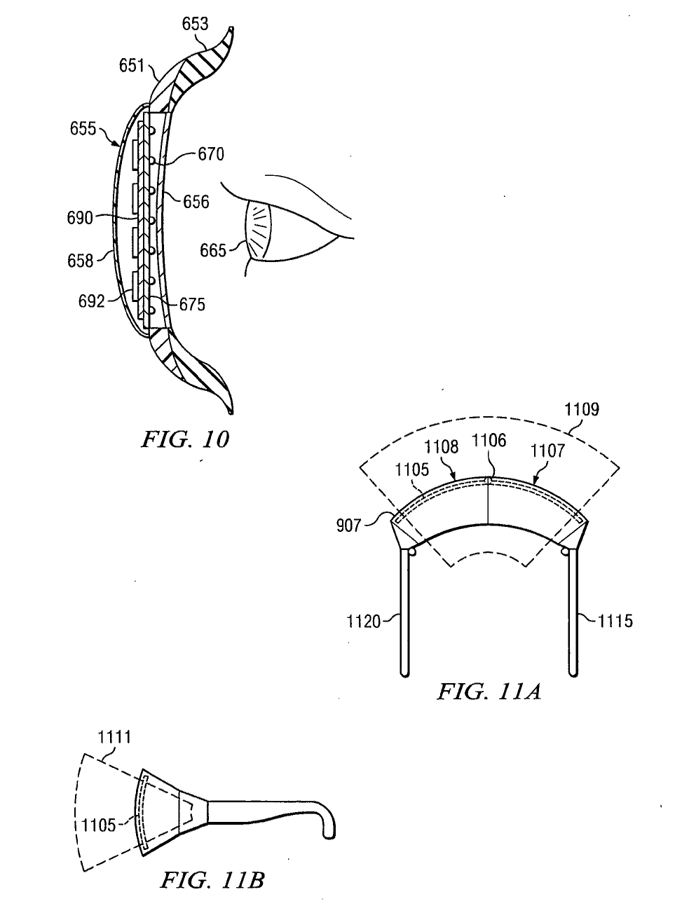

Eye-exercise goggles 650 serve as a means for exercising a user's eye muscles by lighting a number of LEDs built into the display assemblies and utilizing electronics contained therein. To the display assembly 655 is attached a set of LEDs 670. Switching to FIG. 10, a cross-section of the frame 651 shows that set of LEDs 670 in the display assembly 655 are mounted on LED assembly 675 so that the LEDs illuminate the space toward eye 665. A semi-transparent inner cover 656 is attached to frame 651 to enclose the display assembly 655 on the inside and an outer cover 658 is attached to frame 651 to enclose the display assembly 655 on the outside. LED assembly 675 is attached to a control circuit 690. LED assembly 675 is made of a separate PCB and mechanically and electrically attached to control circuit 690 using board-to-board inline connectors. Control circuit 690 has attached to it a set of electronic IC components 692 that function together to control LED assembly 675 so that LEDs in the set of LEDs 670 illuminate in pre-defined sequences similar to those described for eye-exercise goggles 50 above. Control circuit 690 is similar to control circuit 90R with the oscillator function 310 of control circuit 90L included. There is only one control circuit, one display and one set of LEDs for the eye-exercise goggles 650. The set of LEDs 670 are arranged in an ellipse surrounding near the edge of display assembly 655, but otherwise the LED assembly 675 is electronically similar to LED assembly 75L or 75R and the circuit functioning in the same way as for eye-exercise goggles 50.

Returning to FIG. 9, frame 651 has a battery 657 stored in a battery compartment that is integrated into frame 651, battery 657 being electrically connected to control circuit 690 and providing power for it via an on/off button 680 which is integrated into frame 651, on/off button 680 being connected to battery 657 and control circuit 690. Other electronic controls are integrated into the goggle frames: a timing control button 682 which is electrically connected to control circuit 690 and used for setting the rate at which the LEDs are illuminated; a repetitions control button 683, which is electrically connected to control circuit 690 and is used for setting a number of repeated illumination sequences.

The frame 651 is made of molded plastic as are inner cover 656 and outer cover 658. LEDs are chosen to be green as in the preferred embodiment. The inner covers are typically transparent to green light but may block other colors, the outer covers are typically opaque. The strap 660 is made of an elastic material such as rubber. The frame 651, display assembly 655 are constructed so that the display assembly 655 is held in place by snapping the inner covers and outer covers into place.

Having the LEDs arranged into a single elliptical pattern as in the second embodiment has the advantage of exercising the eyes near the periphery of vision and in full cooperation with each other. The cooperation between the left and the right eye in focusing on a single LED causes further inducement of correct brain to eye coordination. Brain to eye coordination is further exercised when the brain is caused to focus more intently on the lighted LED as for example, when the intensity of the LED pattern is modulated slowly to increase and decrease as the pattern progresses around the ellipse or along the linear patterns.

Referring to FIGS. 11A and 11B, an alternate embodiment of the physical shape of the present invention is shown. In FIG. 11A, bifurcated and rounded PCB board 1105 is shown encased in a rounded face shield. The face shield is comprised of a left half 1108 and a right half 1107. Earpiece 1120 is hinged to left half 1108. Earpiece 1115 is hinged to right half 1107. The rounded PCB board allows a wider field of view 1109 than with flat embodiments of the PCB board. In FIG. 11B, the side view of this preferred embodiment shows the shape of the face shield. The face shield is semispherical. Those skilled in the art will recognize that the field of view vertically 1111 is also extended by the shape of the PCB board 1105. The distance from the wearer's eyes is constant for each orbital position of the wearer's eyes. The embodiment is provided with a hinge 1106. In use, the face shield is “reverse folded,” bringing the faces of the left half and the right half together and folding the earpieces inward.

While the preferred embodiment provides adequate description of the invention, other embodiments are easily conceived using slightly different materials or different electronic configurations. For example, the control electronics of control circuit 90R may all be placed on one frame and a ribbon cable connected to the LED assembly of both frames established to the control circuit. The invention herein should not be limited by similar improvements so conceived.

1. A set of goggles for exercising the muscles of the eye wherein the exercise consists of linear eye movement and circular eye movement, the set of goggles being attached to a wearer's head and positioned in front of the wearer's eyes comprising:
(a) a left frame member;
(b) a right frame member;
(c) a hinge connecting the left frame member and the right frame member;
(d) a seal means, attached to the left frame member and the right frame member for creating a light tight seal between the left frame member and the right frame member and the wearer's head;
(e) a first display assembly attached to the left frame member behind the seal means;
(f) a second display assembly attached to the right frame member behind the seal means;
(g) the first display assembly and the second display assembly forming a semispherical surface where a distance from the wearer's eyes is constant for all orbital positions of the wearer's eyes;
(h) the first display assembly and the second display assembly further comprise:
a plurality of LEDS;
a control circuit electrically connected to the plurality of LEDs and attached to the first display assembly and the second display assembly containing an electronic circuit for automatically activating the plurality of LEDs in a sequential manner;
a power supply connected to the electric circuit for providing electric current to the electric circuit and the plurality of LEDs; and,
(i) the plurality of LEDs further comprising:
a first set of LEDs arranged in a horizontal line,
a second set of LEDs arranged in a vertical line,
a third set of LEDs arranged in an oblique line,
a fourth set of LEDs arranged in a circular pattern adjacent the periphery of the first and second display assemblies.

2. The set of goggles of claim 1 further comprising a repetition switch means for setting the number of repetitions of lighting the plurality of LEDs.

3. The set of goggles of claim 1 wherein the sequential manner comprises a rate vector defining a rate of advancement in lighting the plurality of LEDs and an intensity vector defining a modification of LED intensity within the plurality of LEDs.

4. The set of goggles of claim 3 wherein the rate vector and the intensity vector are related according to one of the group of:
the advancement in lighting the plurality of LEDs is synchronous with the modification of LED intensity;
the advancement in lighting the plurality of LEDs is not synchronous with the modification of LED intensity; and
the rate of advancement in lighting the plurality of LEDs and the modification of LED intensity is governed by position within the plurality of LEDs.

5. The set of goggles of claim 1 wherein the display assembly includes a semi-transparent inner cover between the plurality of LEDs and the wearer's eyes.

6. The set of goggles of claim 1 further comprising a translucent inner cover and a set of transparent figures adjacent each LED of the plurality of LEDs.

7. A method of eye-exercise using goggles to be worn on a wearer's head, the goggles including a left frame with a left display assembly and a right frame with a right display assembly, the left display assembly having a left set of LEDs arranged in a left linear horizontal pattern, a left linear vertical pattern, a left linear oblique pattern and a left circular pattern, the right display assembly having a right set of LEDs arranged in a right linear horizontal pattern, a right linear vertical pattern, a right linear oblique pattern and a right circular pattern, the left circular pattern being positioned near the periphery of the left frame, the right circular pattern being positioned near the periphery of the right frame, and a set of control electronics for controlling the left set of LEDs and the right set of LEDs, comprising the steps of:
(a) placing the goggles adjacent the eyes of the wearer;
(b) activating the control electronics;
(j) lighting at least one of the left and right linear horizontal patterns;
(k) lighting at least one of the left and right linear vertical patterns;
(l) lighting the left linear oblique pattern;
(m) lighting the right linear oblique pattern;
(n) lighting at least one of the left and right clockwise circular patterns;
(o) lighting at least one of the left and right counterclockwise circular patterns; and
(p) adjusting a lighting rate vector and a lighting intensity vector of the control electronics.

8. The method of claim 7 further comprising the step of impressing a function relating the lighting intensity vector to the lighting rate vector.

9. The method of claim 7 further comprising the step of providing a set of imprinted objects adjacent the left set of LEDs and the right set of LEDs.

10. A face shield for exercising the muscles of a wearer's eyes wherein the exercise consists of linear eye movement and elliptical eye movement at a maximum peripheral limit of travel of the wearer's eyes, the face shield being attached to the wearer's head adjacent the wearer's eyes comprising:
(a) a frame to which a seal is attached for sealing light;
(b) the frame comprised of a left half and a right half;
(c) a means for attaching the face shield to the head;
(d) a display assembly attached to the frame and set in front of the eyes which is further comprised of:
a plurality of LEDs,
a means for modulating the light intensity of the plurality of LEDS,
a control circuit electrically connected to the plurality of LEDs and attached to the display assembly containing electronic circuitry for automatically lighting the plurality of LEDs in a predetermined pattern,
at least one battery holder supported by the frame and containing a battery electrically connected to the control current,
a hinge means, attached to the frame, whereby the face shield can be collapsed into a carrying position where the left half fits generally flush adjacent the right half; and,
(e) the plurality of LEDS further comprising:
a first set of LEDs arranged in a horizontal line,
a second set of LEDs arranged in a vertical line,
a third set of LEDs arranged in an oblique line,
a fourth set of LEDs arranged in an elliptical pattern near the periphery of the display assembly.

11. The face shield of claim 10 further comprising a repetition switch means for setting the number of repetitions of lighting the plurality of LEDs and a timing switch means for setting the frequency at which LEDs in the plurality of LEDs are lit.

12. The face shield of claim 10 wherein the display assembly includes a semi-transparent inner cover between the plurality of LEDs and the wearer's eyes.

13. The face shield of claim 12, wherein the inner cover includes a set of imprinted objects.

14. The face shield of claim 13, wherein the set of imprinted objects include images of at least one of the group of animals, insects, persons, and cartoon characters.

15. The face shield of claim 13 wherein the predetermined pattern and the control circuit enable an animation effect.

16. The face shield of claim 19 wherein the animation effect includes illuminating the set of imprinted objects in a direction selected from the group of horizontal, vertical, oblique, clockwise circular, and counterclockwise circular.

17. The face shield of claim 10 wherein the means for modulating light intensity modulates the light intensity of the plurality of LEDs synchronously with the lighting of the plurality of LEDs.

18. The face shield of claim 10 wherein the means for modulating light intensity modulates the light intensity of the plurality of LEDs asynchronously with the lighting of the plurality of LEDs.

19. The face shield of claim 10 wherein the predetermined pattern includes at least one linear horizontal pattern.

20. The face shield of claim 10 wherein the predetermined pattern includes at least one of the group of a clockwise circular pattern and a counterclockwise circular pattern.
